(19) United States
(12) Patent Application Publication
(10) Pub. No.: US 2008/0079693 A1
(43) Pub. Date: Apr. 3, 2008

(54) Apparatus for displaying presentation information

(75) Inventors: Masayuki Okamoto, Kanagawa (JP); Hideo Umeki, Kanagawa (JP); Kenta Cho, Tokyo (JP); Naoki Iketani, Kanagawa (JP); Yuzo Okamoto, Kanagawa (JP); Keisuke Nishimura, Kanagawa (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/892,065

(22) Filed: Aug. 20, 2007

(30) Foreign Application Priority Data
Sep. 28, 2006 (JP) 2006-264833

(51) Int. Cl. G06F 3/033; G06F 17/00

(52) U.S. Cl. 345/157; 715/273

(57) ABSTRACT

An information displaying apparatus includes a presentation displaying unit that displays presentation information on a display unit, a pointing-input receiving unit that receives a pointing to the display unit, a pointing-area detecting unit that detects a pointing area with respect to a predetermined coordinate area including the displayed presentation information, an attention-area determining unit that determines an attention area with respect to the presentation information based on the detected pointing area and an attention-area determination rule, and a highlight displaying unit that displays the determined attention area in a highlighting manner with respect to the presentation information.

### CROSS-REFERENCE TO RELATED APPLICATIONS

This application is based upon and claims the benefit of priority from the prior Japanese Patent Application No. 2006-264833, filed on Sep. 28, 2006; the entire contents of which are incorporated herein by reference.

### BACKGROUND OF THE INVENTION

1. Field of the Invention

The present invention relates to an information displaying apparatus, an information displaying method, and an information displaying program product.

2. Description of the Related Art

Nowadays, a display device, a projector, or an electronic whiteboard is used in a conference, a class, and the like, which displays presentation data and the like. An explanation; or a discussion is performed using the displayed presentation data. In addition, in the case of using the electronic whiteboard, a writing operation can be performed with respect to the presentation data by detecting a position pointed by a pen device and the like.

In a conference or a class using such devices, there may be a situation in which it is desired to display again previously referred material or written contents. In this case, a user performs a search operation with respect to an area of a hard disk drive (HDD) or the like in which material and the like are stored, and displays searched material and the like. Otherwise, a personal computer (PC) owned by a user who possesses the material is connected again to the display device to display the material. If contents written in a conference and the like are not stored, it is impossible to display the contents because all the written contents are lost. In this manner, a considerable amount of human and time cost is required to present the previously presented contents again.

Therefore, a means for managing or utilizing important contents of a conference has been proposed. For instance, a technology has been proposed, which presents recorded conference data or class data again by providing a user interface for recording all contents of a conference of a class and searching the recorded contents.

As for the user interface for browsing the recorded conference data or class data later and creating a conference log, for example, there is a technology described in Japanese Patent No. 3185505. The technology described in the above literature enables a user to create a conference log with ease by displaying a timeline and a screen displayed every hour as a heading image in association with each other.

However, with the technology described in the above literature, in the case where a user searches a desired screen and displays the searched screen, it is not possible to instantly recognize an attention area pointed during the conference even if a desired display screen can be successfully detected from massive amount of information.

### SUMMARY OF THE INVENTION

According to one aspect of the present invention, an apparatus for displaying presentation information, includes a presentation displaying unit that displays the presentation information on a display unit; a pointing reception unit that receives a pointing to the display unit from a user; a pointing-area detecting unit that detects a pointing area with respect to a predetermined coordinate area including the displayed presentation information; a rule storing unit that stores an attention-area determination rule for specifying an attention area from the pointing area; an attention-area determining unit that determines an attention area with respect to the presentation information based on the pointing area detected by the pointing-area detecting unit and the attention-area determination rule; and a highlight displaying unit that displays the attention area determined by the attention-area determining unit in a highlighting manner with respect to the presentation information.

According to another aspect of the present invention, a method for displaying presentation information, includes displaying the presentation information on a display unit; receiving a pointing to the display unit from a user; detecting a pointing area with respect to a predetermined coordinate area including the displayed presentation information; determining an attention area with respect to the presentation information based on the detected pointing area and an attention-area determination rule stored in a rule storing unit; and highlight-displaying the determined attention area in a highlighting manner with respect to the presentation information.

A computer program product according to still another aspect of the present invention causes a computer to perform the method according to the present invention.

### BRIEF DESCRIPTION OF THE DRAWINGS

FIG. 1 is a schematic diagram illustrating a conference supporting system according to an embodiment of the present invention;

FIG. 2 is a block diagram illustrating a functional configuration of a meeting server and a conference-log storage according to the present embodiment;

FIG. 3 is a schematic diagram for explaining an example of a type of feature amount recorded in an external-data storing unit;

FIG. 4 is a schematic diagram for explaining an example of a data structure of an event management table stored in a presentation-data storing unit;

FIG. 5A is a schematic diagram illustrating an example of a screen displayed on a whiteboard by a video displaying unit;

FIG. 5B is a schematic diagram illustrating an example 3: of a screen displayed on a whiteboard by a video displaying unit according to a modification of the present embodiment;

FIG. 6 is a schematic diagram for explaining an example of a data structure of an attention-area determination rule used by the meeting server according to the present embodiment;

FIG. 7A is a schematic diagram illustrating a first example of highlight-displaying an attention area determined by the meeting server based on a pointing area;

FIG. 7B is a schematic diagram illustrating a second example of highlight-displaying an attention area determined by the meeting server based on a pointing area;

FIG. 7C is a schematic diagram illustrating a third example of highlight-displaying an attention area determined by the meeting server based on a pointing area;

FIG. 8 is a schematic diagram for explaining an example of a data structure of an attention-area management table stored in an attention-area storing unit;

FIG. 9 is a schematic diagram for explaining an example of a data structure of a heading-information management table stored in a heading-information storing unit;

FIG. 10 is a flowchart of a processing procedure performed by the meeting server at the time of starting a conference;

FIG. 11 is a flowchart of a processing procedure for identifying an attention area and generating heading information performed by the meeting server;

FIG. 12 is a flowchart of a processing procedure for generating a relation between attention areas performed by an attention-area-relation generating unit;

FIG. 13 is a schematic diagram for explaining a concept in the case that an attention area determined by the meeting server agrees with a previously determined attention area;

FIG. 14 is a schematic diagram for explaining a concept in the case that an attention area determined by the meeting server is moved by a zooming operation;

FIG. 15 is a schematic diagram illustrating an example of a display screen of relevant heading image data displayed by the video displaying unit;

FIG. 16 is a flowchart of a processing procedure for displaying the heading image data on a timeline performed by the video displaying unit; and

FIG. 17 is a schematic diagram for illustrating a hardware configuration of the meeting server.

### DETAILED DESCRIPTION OF THE INVENTION

Exemplary embodiments of an information displaying apparatus, an information displaying method, and an information displaying program product according to the present invention are explained in detail below with reference to the accompanying drawings. In the present embodiments, an example is explained in which the information displaying apparatus according to the present invention is applied to a meeting server. However, the information displaying apparatus according to the present invention can be applied to various schemes other than the meeting server.

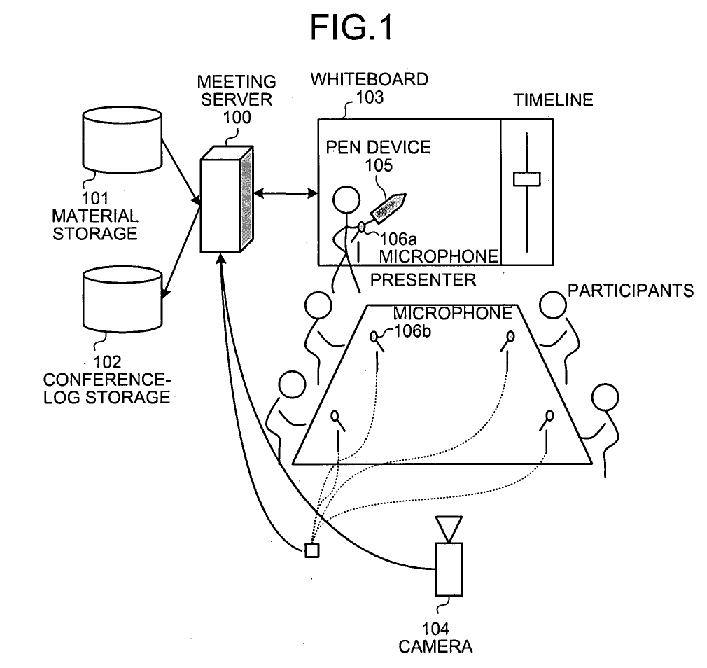

As shown in FIG. 1, a conference supporting system according to an embodiment includes a whiteboard 103, a meeting server 100, a material storage 101 in which presentation data is accumulated, a conference-log storage 102, a camera 104 for shooting scenes of participants, a presentation screen, and the like, a pen device 105 for performing a memo writing or a pointing on a displayed screen, and microphones 106a to 106n for recording a speech of a participant.

The presentation data described above is data displayed on a whiteboard or a monitor at a meeting such as a conference and a class. The presentation data includes, as well as data formed for a presentation, all kinds of materials presented at a conference or a class, for example, a document file such as a report, data created by a spreadsheet software, and moving image data.

The whiteboard 103 displays thereon presentation data, a memo writing input by a user, or heading information stored as conference information. Furthermore, the whiteboard 103 displays thereon a timeline interface indicating a progress of a conference and the like. A user can call previously recorded information on the whiteboard 103 by operating a slider provided with the timeline interface. The previously recorded information is accumulated in the conference-log storage 102.

The meeting server 100 performs a display process of displaying presentation data used at a conference, such as data for PowerPoint (Registered Trademark), on the whiteboard 103 and an editing process of editing presentation data input from a user.

In the material storage 101, the presentation data is accumulated.

The conference-log storage 102 records therein the presentation data displayed or edited by a user at a conference. Furthermore, the conference-log storage 102 records therein an order of switching a screen displayed on the whiteboard 103 in an identifiable manner. In addition, the conference-log storage 102 stores therein a feature amount converted from information input from the pen device 105 and the like in association with time information indicating a predetermined time window.

The camera 104 shoots scenes of the participants, the presentation screen, and the like. The pen device 105 is used by a user to perform a memo writing and a pointing on a screen on which the presentation data is displayed. The microphones 106a to 106n record a speech of the participants.

The conference supporting system according to the present embodiment records a feature amount such as a memo writing by a pen device, a mouse, or the like and a pointing operation during a conference, calculates an attention area for each conference scene from the recorded feature amount, and generates heading information indicating the calculated attention area. With this configuration, the conference supporting system according to the present embodiment is able to identify an attention area on which an attention was paid in during the past conference, and at the same time, to extract arbitrary information from the attention area.

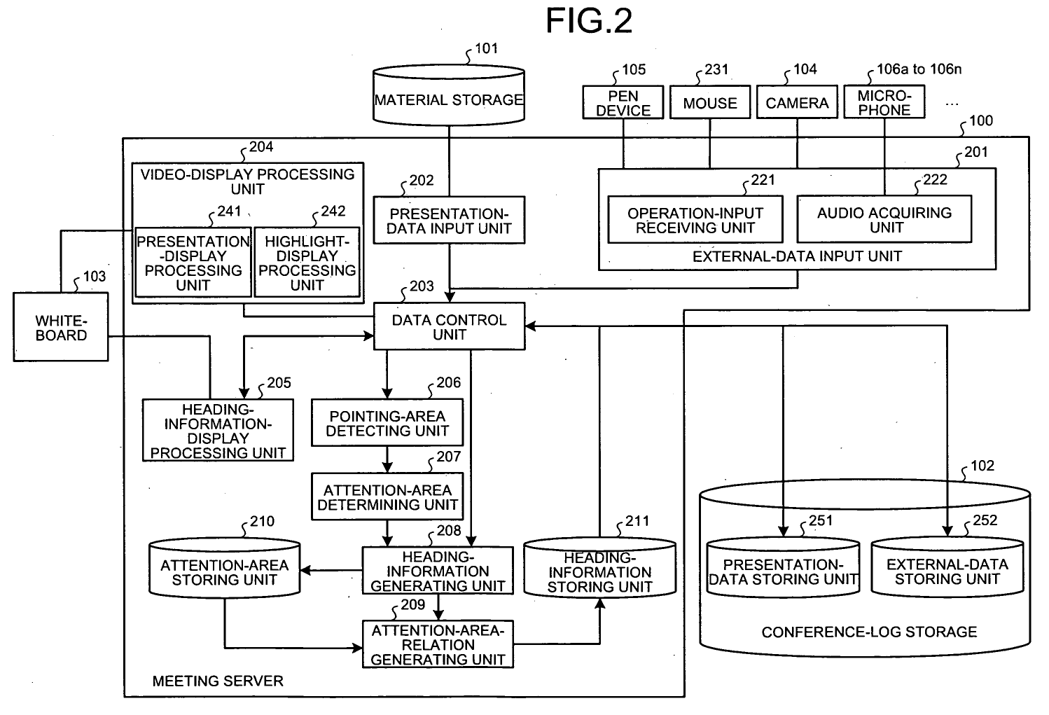

As shown in FIG. 2, the conference-log storage 102 includes a presentation-data storing unit 251 and an external-data storing unit 252.

The external-data storing unit 252 records therein external data input from the pen device 105, a mouse 231, the camera 104, and the microphones 106a to 106n. Furthermore, the external-data storing unit 252 records therein a feature amount of the external data while presenting the presentation data. The feature amount of the external data is generated for every external data, and is recorded separately in the external-data storing unit 252.

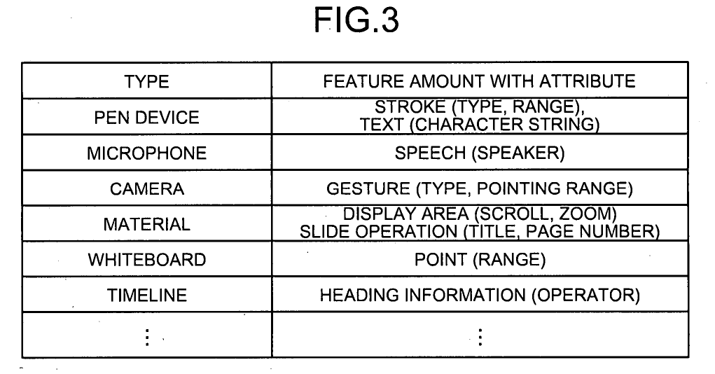

A data control unit 203 of the meeting server 100 extracts the feature amount shown in FIG. 3 for each connected device and displayed presentation data. After extracting the feature amount, the data control unit 203 records the extracted feature amount in the external-data storing unit 252 in association with the time at which the external data is input. If the feature amount contains an attribute regarding the external data, the data control unit 203 also stores the attribute in the external-data storing unit 252 in association with the feature amount and the time. Examples of the feature amount to be extracted and the attribute of the feature amount are explained below.

As shown in FIG. 3, a stroke or a text input from the pen device 105 is extracted as a feature amount of a pen device. The stroke a description of a specific figure, such as circle and an underline, recognized from an input from the pen device 105. The data control unit 203 extracts a type of the figure and a range covered by the figure on the whiteboard as the attribute with respect to the stroke. Then, the data control unit 203 records the stroke (including the attribute, the same goes for the following) in association with the time.

In addition, the data control unit 203 performs a character recognition for the data input from the pen device 105, and records text information or character-string information described by the pen device 105 in association with the time.

A speaker who made a speech and contents of the speech recognized from audio data input from the microphones 106a to 106n are extracted as a feature amount of a microphone. The data control unit 203 performs an audio recognition with respect to the audio data input from the microphones 106a to 106n, and extracts a character string of contents of a recognized speech. The microphones 106a to 106n are placed in front of respective participants. Therefore, the data control unit 203 can identify a speaker from a volume level of an input microphone. The identified speaker becomes an attribute of the speech. The data control unit 203 records the speech in association with the time at which the speech is made.

Furthermore, a gesture performed by the participants of the conference is extracted from video data input from the camera 104 and the like as a feature amount of a camera. The data control unit 203 can extract a gesture performed by a participant by performing a video recognition with respect to the video data input from the camera 104. The gesture is information on an operation performed by the participant, including, for example, a type of the operation performed by the participant and a pointing range on the whiteboard 103 pointed by the participant. The data control unit 203 records the extracted gesture in association with the time.

In addition, a display area or a slide of the displayed presentation data is extracted as a feature amount of the presentation data from an operation performed on the presentation data. The display area is determined from a scrolling or a zooming operation for displaying a specific portion of the presentation data, and extracted as the feature amount. The scrolling or the zooming operation becomes an attribute of the display area. The slide indicates contents displayed as the presentation data, and is extracted as the feature amount from the presentation data. As for the attribute of the slide, information such as a title and a page number among the entire slide is also extracted.

A pointer (range) pointed by the pen device 105, the mouse 231, and the like with respect to the whiteboard 103 is extracted as a feature amount of the whiteboard 103. In addition, a range pointed by using a pointer function is also extracted as an attribute of the whiteboard 103.

Heading information displayed as the past presentation data by a user's operation of the timeline with respect to the whiteboard 103 is extracted as a feature amount of the timeline. The heading information in the timeline includes a displayed video. Furthermore, as for an attribute of the heading information, information on an operator who performed an operation with respect to the timeline when displaying the heading information is also extracted.

Those extracted feature amounts are used for determining an attention area that indicates a portion of the presentation data and the like having got an attention from the participants at the conference. A method of determining the attention area will be explained later.

The presentation-data storing unit 251 records a video of the presentation data used as a presentation and various pieces of information such as a file attribute of the presentation data and a destination to be browsed. Furthermore, when an editing or the like is performed on the presentation data during the conference, the presentation-data storing unit 251 records the presentation data before and after the editing.

In addition, the presentation-data storing unit 251 records an event occurred during the conference as an event management table. The presence of the event is determined based on the feature amounts described above.

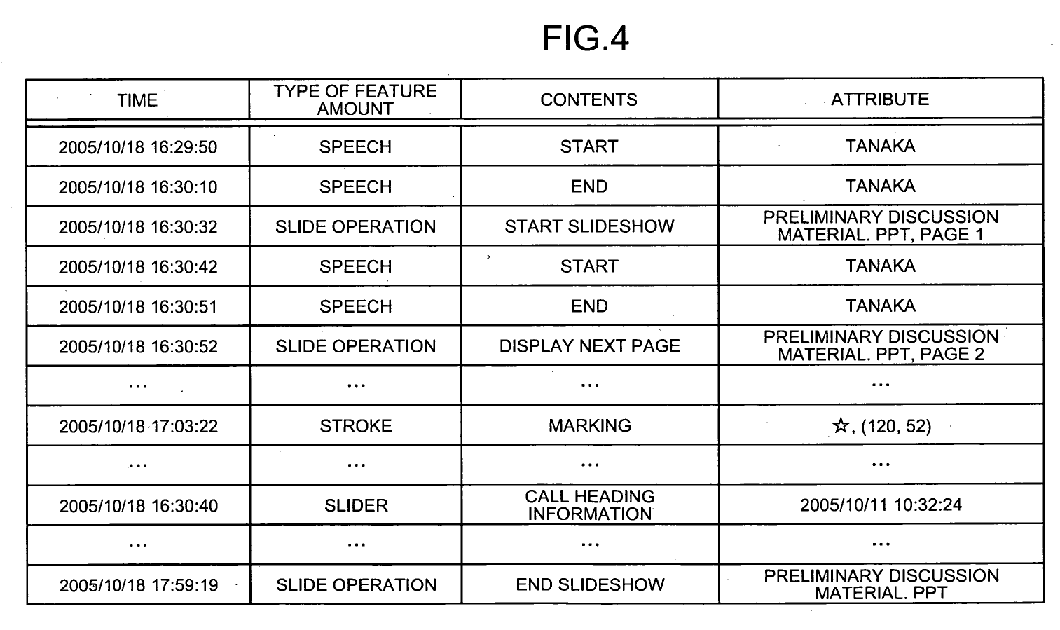

As shown in FIG. 4, the event management table stores time (time stamp), type of the feature amount, contents, and attribute in association with each other. The time, the feature amount, and the attribute are extracted from the processes described above. The contents are determined by the data control unit 203 from the type of the extracted feature amount. The data control unit 203 performs a process of adding a record according to the extracted feature amount to the event management table. The event management table is used when implementing a timeline interface including heading information. The process of implementing the timeline interface will be explained later.

Referring back to FIG. 2, the meeting server 100 includes an external-data input unit 201, a presentation-data input unit 202, the data control unit 203, a video displaying unit 204, a heading-information displaying unit 205, a pointing-area detecting unit 206, an attention-area determining unit 207, a heading-information generating unit 208, an attention-area-relation generating unit 209, an attention-area storing unit 210, and a heading-information storing unit 211.

The external-data input unit 201 includes an operation-input receiving unit 221 and an speech acquiring unit 222, and receives data input from the pen device 105, the mouse 231, the camera 104, and the microphones 106a to 106n. A pen input and speech information input from the above devices are also recorded in the external-data storing unit 252 together with video projection data.

The operation-input receiving unit 221 receives operation information pointed by the pen device 105 or the mouse 231. The operation-input receiving unit 221 corresponds to a pointing-input receiving unit. Upon the operation-input receiving unit 221 receiving the operation information, it is possible to perform an operation of the presentation data and a memo writing to the presentation data. The operation of the presentation data includes any kind of operation with respect to the presentation data, such as a zooming operation and a scrolling operation on the presentation data.

The speech acquiring unit 222 acquires speech information input from the microphones 106a to 106n. The acquired speech information is used for detecting a pointing area as well as for recording as the conference data.

The presentation-data input unit 202 makes an input of the presentation data to be displayed on the whiteboard 103. The presentation data is input from, for example, the material storage 101 and a PC of a user. Furthermore, the presentation data to be input can take any type of format, for example, a file and a video signal.

The data control unit 203 performs an overall control of the meeting server 100. Furthermore, the data control unit 203 controls the input presentation data and the input external data. In addition, the data control unit 203 manages the presentation data input from the presentation-data input unit 202 and the external data input from the external-data input unit 201 in an integrated manner based on time information.

For instance, the data control unit 203 extracts, as the integrated management of the input data, the feature amount from the input external data, and stores the extracted feature amount in the presentation-data storing unit 251 in association with the time and the like. In addition, the data control unit 203 stores an event determined to be occurred based on the feature amount in the presentation-data storing unit 251.

The data control unit 203 outputs video data to be displayed to the video displaying unit 204 from the external data including an operation of a user. Furthermore, the data control unit 203 provides a function of reading heading information from the heading-information storing unit 211 and displaying the heading information on the whiteboard 103 in combination with the timeline.

The video displaying unit 204 includes a presentation displaying unit 241 and a highlight displaying unit 242, and displays the presentation data and the like on the whiteboard 103. The presentation displaying unit 241 displays the presentation data on the whiteboard 103, and the highlight displaying unit 242 displays a timeline user interface (UI) on the whiteboard 103. In addition, when the heading information is input from the data control unit 203, the highlight displaying unit 242 displays the heading information in association with the time on the timeline.

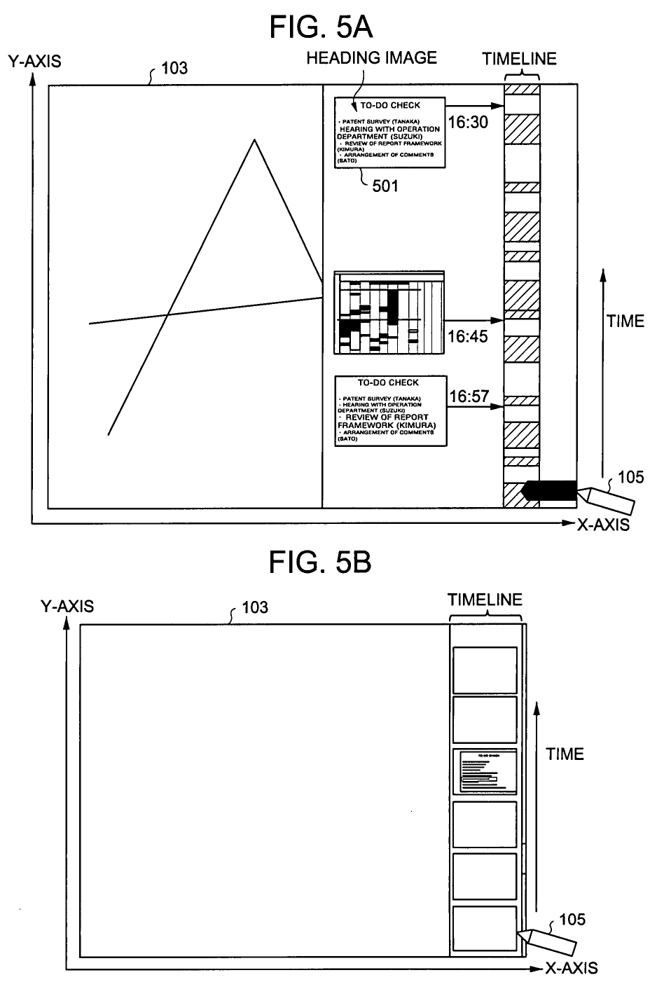

An example is shown in FIG. 5A, in which a heading image is displayed in association with the time displayed on the timeline. A frame divided for every arbitrary time on the timeline is the time window divided for every event shown in FIG. 4. The heading image is an image representing a screen displayed on the whiteboard 103.

The heading image displayed with the timeline does not include all screens, but includes screens that satisfy a predetermined condition only. With this scheme, a user can easily confirm the heading image. The condition for displaying the heading image can be any kind of condition. For instance, the condition can be to display the presentation data including the attention area. As for another example, an evaluation value is calculated based on the feature amount and the attribute for every frame, if the evaluation value exceeds a predetermined threshold, a series of frames is treated as a single group, and a single heading image is displayed for every single group.

On the heading image displayed by the highlight displaying unit 242, the attention area is displayed in a highlighting manner. For instance, “HEARING WITH OPERATION DEPARTMENT (SUZUKI)” 501 included in the heading image shown in FIG. 5A is zoomed in compared to the original presentation data. With this scheme, it is possible to confirm that the zoomed-in area has got an attention during the conference. Performing the highlight display is determined based on the feature amount and the attribute of the feature amount. A processing procedure of the highlight display will be explained later.

The timeline is not limited to the vertical display type, but can be displayed in any direction such as the horizontal direction. Furthermore, the display direction of the timeline can be switched by an operation of a user as appropriate.

Moreover, the heading image displayed with the timeline can take other type of format. For instance, as shown in FIG. 5B, the heading image can be displayed inside the timeline of the whiteboard 103.

Furthermore, it is not limited to display only the heading image with the timeline. For instance, a caption that describes the heading information can be displayed for every heading image. The caption can be generated from the feature amount, the attribute, and the like.

The present embodiment does not limit a display destination of the video displaying unit 204 to the whiteboard 103, but the display process can be performed on any type of display device such as a video projector and a monitor of a PC. In the same manner, the heading-information displaying unit 205 does not limit a display destination, either.

The heading-information displaying unit 205 performs a display process of display data corresponding to heading information selected at the timeline UI. When it is determined that the heading information is selected at the timeline UI by an operation of a user, the heading-information displaying unit 205 instructs the data control unit 203 to acquire display data corresponding to the heading information. With the instruction from the heading-information displaying unit 205, the data control unit 203 acquires the presentation data to be displayed from the presentation-data storing unit 251 as the display data. When the display data is input from the data control unit 203, the heading-information displaying unit 205 displays the input display data on the whiteboard 103.

The pointing-area detecting unit 206 acquires the presentation data and the external data from the data control unit 203, and detects a pointing area pointed by a user with respect to a coordinate area including video data displayed on the whiteboard 103 at the conference.

The attention-area determining unit 207 determines an attention area with respect to the presentation data from the pointing area detected by the pointing-area detecting unit 206. The attention-area determining unit 207 includes a rule storing unit 261. The rule storing unit 261 records a predetermined attention-area determination rule. The attention-area determining unit 207 can determine the attention area from the pointing area by using the attention-area determination rule.

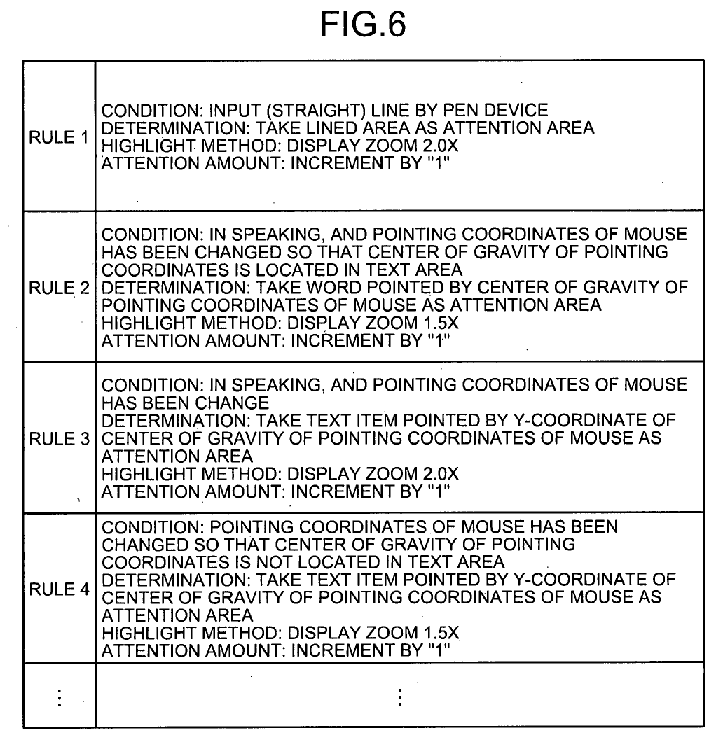

As shown in FIG. 6, the attention-area determination rule contains condition, determination, highlight method, and attention amount in association with each other. The attention-area determining unit 207 determines whether anyone of the feature amount, the attribute, and the detected pointing area agrees with the condition. When it is determined that the condition is met, the attention-area determining unit 207, determines that it is possible to identify the attention area by using the attention-area determination rule, and determines an area described in the determination as the attention area.

The attention-area determination rule is not limited to the one shown in FIG. 6. For instance, when a zooming operation or a slider operation on the presentation data by a user is detected, the presentation data displayed after the operation is performed can be considered to be included in the attention area. Namely, the fact that the user performed such operation means that it is highly possible that the attention area is included in the presentation data. In this manner, the attention-area determination rule can be defined such that the attention area is determined based on various operations performed by the participants.

Furthermore, the attention-area determining unit 207 outputs information determined as described above to the heading-information generating unit 208. With this scheme, the determined information becomes stored in the attention-area storing unit 210.

In the same manner, the attention-area determining unit 207 outputs the attention amount and a type of the highlight display associated in the rule that agrees with the condition to the heading-information generating unit 208. With this scheme, a highlight display method for the attention contents can be specified at the time of generating a heading image.

In some cases, a plurality of attention-area determination rules agrees with respect to a single pointing area. In this case, because a plurality of attention areas exists with respect to a single pointing area, a plurality of highlight display process will be performed.

The heading-information generating unit 208 generates heading information to be displayed with the timeline, based on information corresponding to the attention area input from the attention-area determining unit 207. The heading information includes heading image data, a caption to be displayed with the timeline, and the like. The heading-information generating unit 208 outputs the generated heading information to the attention-area-relation generating unit 209.

For instance, the heading-information generating unit 208 specifies an attention area in image data presented as the presentation data based on the information input from the attention-area determining unit 207. After specifying the attention area, the heading-information generating unit 208 performs a process indicated by the type of the highlight display with respect to the specified attention area of the image data. Then, the heading-information generating unit 208 generates the image data on which the process is performed, as the heading image data. Displaying the heading image data enables the user to recognize the attention area. The caption to be displayed with the timeline is generated based on the input information.

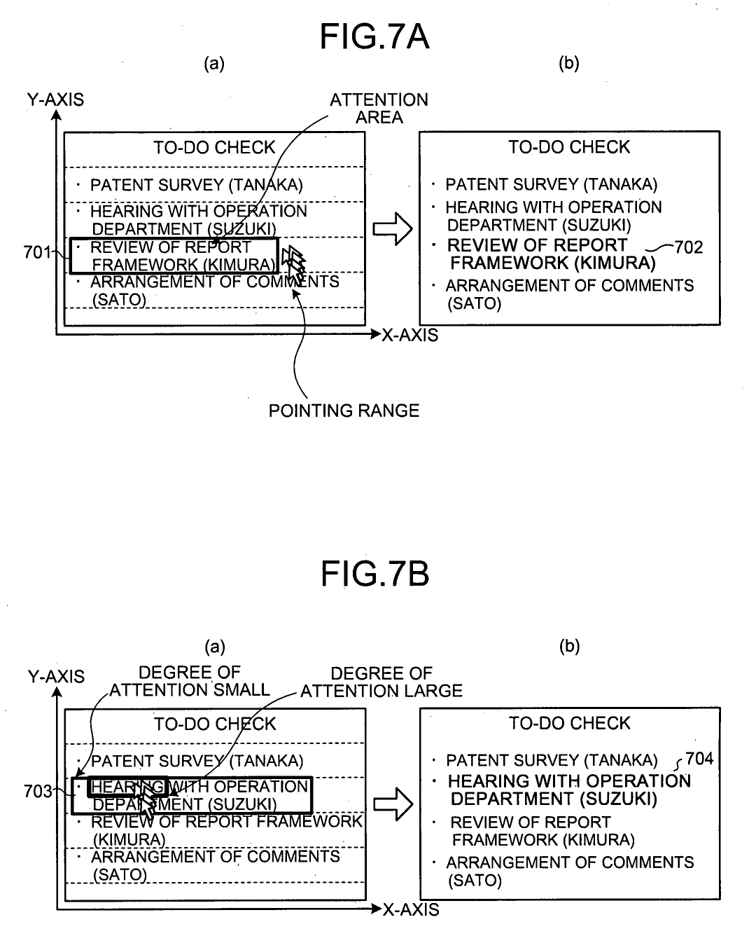

A highlight display of the attention area is explained below with reference to FIG. 7A. The pointing-area detecting unit 206 specifies a pointing range pointed by the mouse 231 that is operated by the user, as the pointing area in a coordinate area on a screen of the presentation data.

The attention-area determining unit 207 determines the attention area from the pointing area based on the attention-area determination rule shown in FIG. 6. In the coordinate area in which the presentation data is displayed, each area divided by a dotted line in screen (a) shown in FIG. 7A is taken as a text item.

Then, the attention-area determining unit 207 determines whether each rule defined in the attention-area determination rule can be applied. In the example shown in the screen (a) of FIG. 7A, because no speech is performed and no pen input is performed, the conditions of “Rule 1” to “Rule 3” cannot be applied. Therefore, according to “Rule 4”, the attention-area determining unit 207 determines a text area 701 in which a pointing area is present, as the attention area.

In addition, because the highlight method of “Rule 4” is display zoom 1.5 times, the heading-information generating unit 208 generates image data in which the text included in the text area 701 is zoomed in by 1.5 times. As shown in screen (b) of FIG. 7A, the user can recognize that the text area included in the attention area is highlighted, because an attention area 702 corresponding to the pointed area is displayed in a magnifying manner in the heading image data generated by the heading-information generating unit 208.

In the example shown in FIG. 7B, the pointing range is on the word “HEARING”, and a speech is performed by a participant without a pen input. In this case, “Rule 2” and “Rule 3” can be applied. According to “Rule 2”, the attention-area determining unit 207 determines the word “HEARING” in the pointing area as the attention area. In addition, according to “Rule 3”, the attention-area determining unit 207 determines a text item 703 in which the pointing area is present, as the attention area. As shown in screen (b) of FIG. 7B, in the heading image data generated by the heading-information generating unit 208, the highlight process is performed in two stages for an attention area 704. Specifically, “HEARING WITH OPERATION DEPARTMENT (SUZUKI)” is magnified by display zoom 2.0 times, and “HEARING” is magnified by display zoom 1.5 times.

In addition, although it is not shown in FIG. 6, the attention-area determination rule also contains a condition of determining the attention area based on feature amount extracted from audio data and the like. In the example shown in FIG. 7C, the pointing range is not present in the text area, and a speech is performed by a participant so that the feature amount of the speech “HEARING” is extracted. In this case, because the word “HEARING” in the text item including the pointing range agrees with the feature amount of the speech “HEARING”, the word “HEARING” is determined as the attention area. In addition, from the pointing range, a text item 705 is determined as the attention area. As shown in screen (b) of FIG. 7C, in the heading image data generated by the heading-information generating unit 208, the highlight process is performed in two stages for an attention area 706. Specifically, “HEARING WITH OPERATION DEPARTMENT (SUZUKI)” is magnified by display zoom 2.0 times, and “HEARING” is magnified by display zoom 1.5 times.

After generating the heading image data, the heading-information generating unit 208 stores a file name of the generated heading image data in the attention-area storing unit 210 in association with information input from the attention-area determining unit 207.

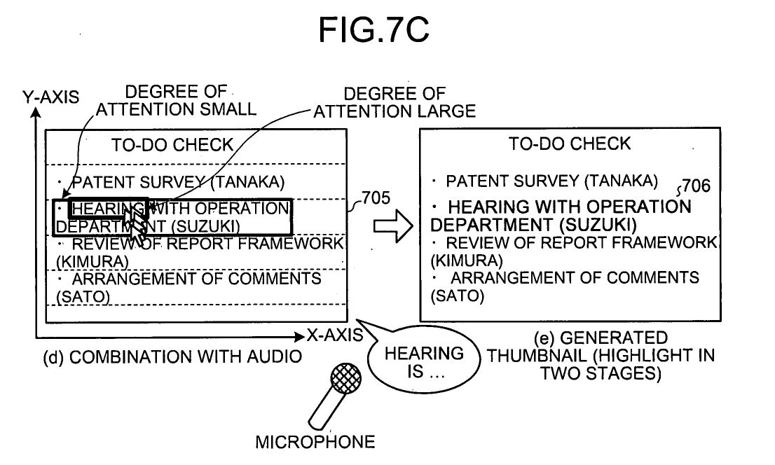

The attention-area storing unit 210 stores therein the attention area determined by the attention-area determining unit 207. As shown in FIG. 8, in an attention-area management table, each attention area is managed by an attention area ID. Each attention area is configured with attention-area determination time, contents of attention (contents described in the attention area), type of feature amount constituting the attention area, amount of attention, type of highlight display, and relevant attention area ID and thumbnail (file name of the heading image data).

In this manner, the heading image including the attention area stored in the attention-area storing unit 210 is displayed in association with a frame from which the attention area is extracted in the timeline on the whiteboard 103. Furthermore, in the heading image, the contents included in the attention area are displayed in a highlighting manner by a process performed by the heading-information generating unit 208.

The attention-area-relation generating unit 209 generates a relation between the attention areas from the attention area stored in the attention-area storing unit 210, the heading information generated by the heading-information generating unit 208, and the existing heading information stored in the heading-information storing unit 211. After generating the relation between the attention areas, the attention-area-relation generating unit 209 stores the heading information generated by the heading-information generating unit 208 in the heading-information storing unit 211. A method of generating the relation between the attention areas will be explained later. Upon generating the relation between the attention areas, the attention-area-relation generating unit 209 adds an attention area ID that is considered to be related to a “relevant attention area ID” field in the attention-area management table shown in FIG. 8. The attention ID can be acquired from an association between ID and time in the attention-area management table shown in FIG. 8.

The heading-information storing unit 211 stores therein the heading information generated by the heading-information generating unit 208. At the same time, the heading-information storing unit 211 manages heading information other than the heading image data in a heading-information management table.

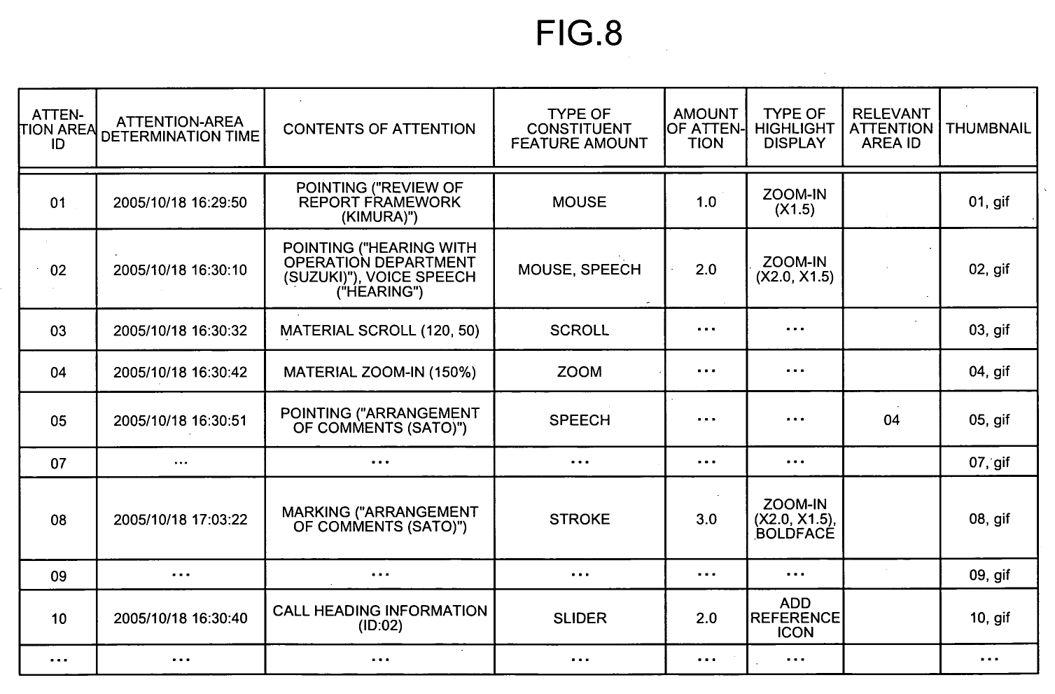

As shown in FIG. 9, the heading-information management table contains heading start time, contents of heading, and relevant heading time, in association with each other. By using the heading start time as a search key, it is possible to specify a record. The relevant heading time becomes a search key for specifying relevant heading information. A process of acquiring the relevant heading information and its association will be explained later.

The heading-information storing unit 211, the attention-area storing unit 210, the presentation-data storing unit 251, and the external-data storing unit 252 can be formed with any type of generally used storage unit such as an HDD, an optical disk, a memory card, and a random access memory (RAM).

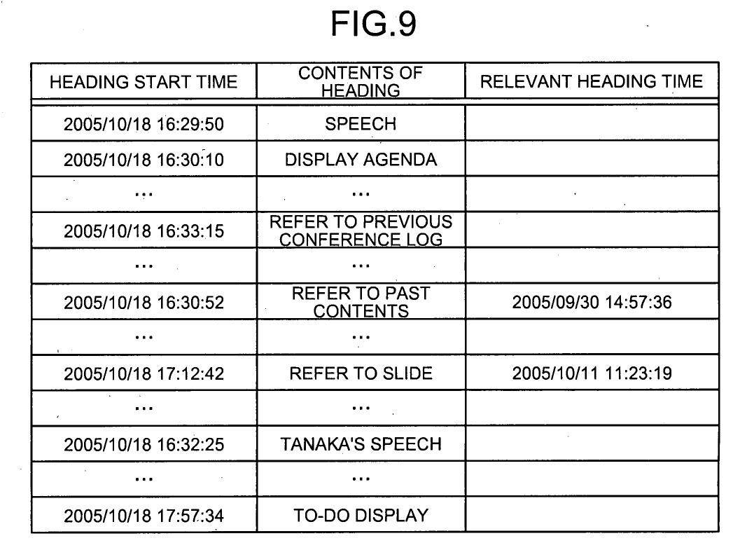

A processing procedure performed by the meeting server 100 at the time of starting a conference is explained below with reference to FIG. 10.

The presentation-data input unit 202 of the meeting server 100 makes an input of presentation data to be used at a conference from the material storage 101 and a PC of a user (Step S1001). When the conference starts, the data control unit 203 of the meeting server 100 starts to record the feature amount (Step S1002).

Subsequently, the presentation displaying unit 241 processes a display of the input presentation data (Step S1003). After that, the external-data input unit 201 processes an input of external data from a connected device and the like (Step S1004).

The data control unit 203 records conference information with respect to the conference-log storage 102 (Step S1005). The conference information includes image information displayed on the whiteboard 103, a moving image from the camera 104 recording scenes of the conference, an audio acquired from the microphones 106a to 106n, and the like. Those pieces of information are stored in the external-data storing unit 252 of the conference-log storage 102.

The data control unit 203 extracts the feature amount for every type shown in FIG. 3 from the input external data, and records the extracted feature amount in the external-data storing unit 252 (Step S1006). Furthermore, the time at which the external data is input is recorded in association with the conference information and the feature amount.

From the extracted feature amount, an identification of an attention area and an identification of heading information are performed (Step S1007).

Then, the data control unit 203 determines whether the conference is over (Step S1008). When it is determined that the conference is not over (No at Step S1008), the process is performed again from the display of the presentation data (Step S1003).

On the other hand, when it is determined that the conference is over (Yes at Step S1008), the process ends.

Finally, all the information and all the feature amount acquired or generated through the conference are stored in the conference-log storage 102, the heading-information storing unit 211, and the attention-area storing unit 210.

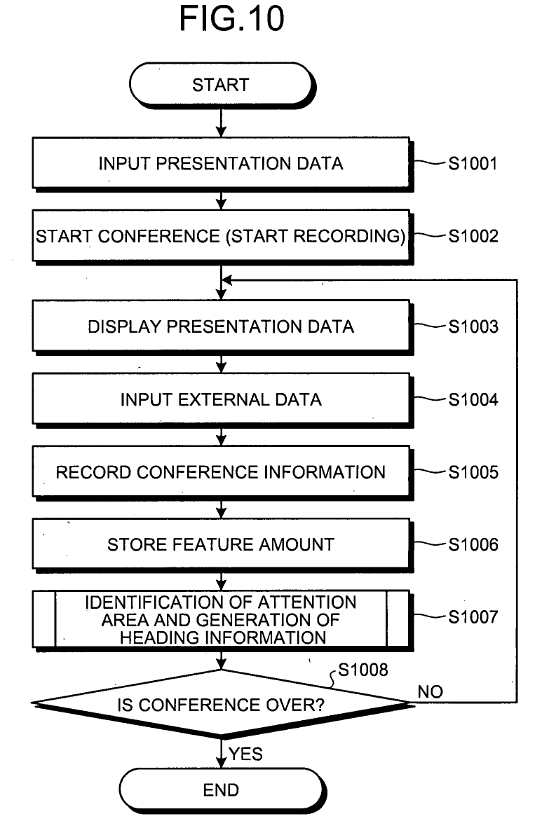

A processing procedure for identifying the attention area and generating the heading information performed at Step S1007 shown in FIG. 10 is explained below with reference to FIG. 11.

The pointing-area detecting unit 206 detects a pointing area in a coordinate area on a screen of the presentation data from the feature amount extracted at Step S1006 shown in FIG. 10 (Step S1101).

The attention-area determining unit 207 determines an attention area based on the detected pointing area, the feature amount, and an attention-area determination rule (Step S1102).

The heading-information generating unit 208 generates heading information based on the determined attention area and the like (Step S1103). After generating the heading information, the heading-information generating unit 208 stores information on the attention area in the attention-area storing unit 210 (Step S1104).

The attention-area-relation generating unit 209 generates a relation between the attention areas from the attention area stored in the attention-area storing unit 210, the generated heading information, and the existing heading information (Step S1105).

After generating the relation between the attention areas, the attention-area-relation generating unit 209 stores information on the heading information in the heading-information storing unit 211 (Step S1106).

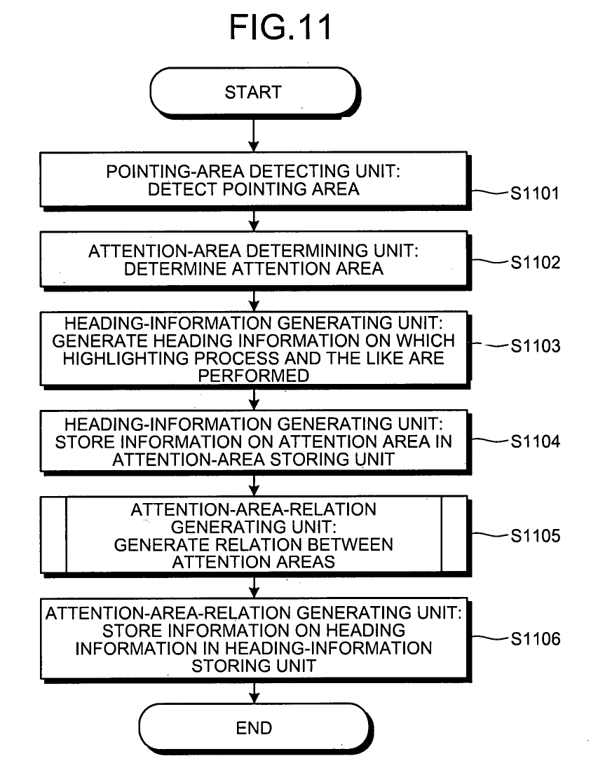

A processing procedure of generating a relation between the attention areas performed by the attention-area-relation generating unit 209 at Step S1105 shown in FIG. 11 is explained below with reference to FIG. 12.

The attention-area-relation generating unit 209 determines whether the determined attention area agrees with the previously determined attention area (Step S1201).

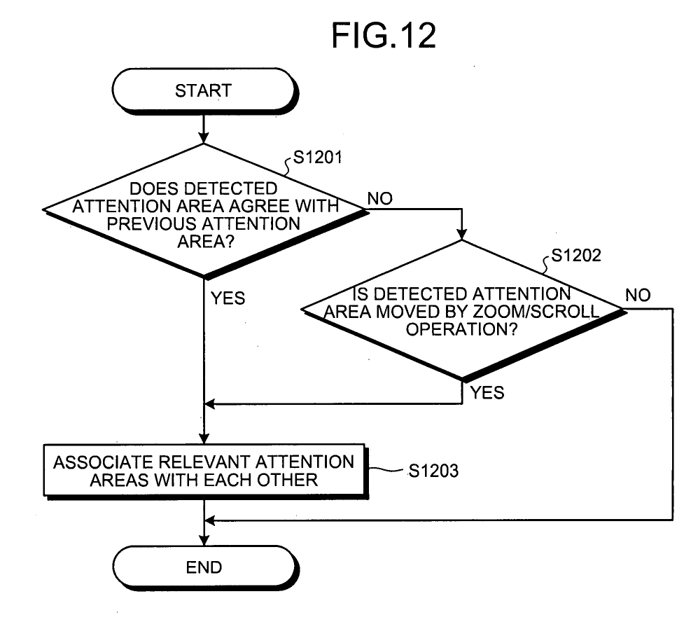

A case where the determined attention area agrees with a previously determined attention area is explained below with reference to FIG. 13. The presentation data shown in screen (a) of FIG. 13 is displayed first. After that, a report shown in screen (b) of FIG. 13 is displayed by an operation of a user. Then, let us consider that the presentation data shown in screen (a) of FIG. 13 is displayed by an operation of the user. In this case, if the user performed the same mouse operation to display the presentation data shown in screen (b) of FIG. 13 before and after displaying the report, the same attention area would be determined.

In this case, the attention-area-relation generating unit 209 construes that there is a relation between the presentation data shown in screen (a) of FIG. 13 and the report shown in screen (b) of FIG. 13, and performs an association with each other. When such association is made, the meeting server 100 can display a screen shown in screen (c) of FIG. 13 on the whiteboard 103. As shown in screen (c) of FIG. 13, the meeting server 100 displays heading image data generated from screen (a) of FIG. 13 on heading image data 1302, and heading image data generated from screen (b) of FIG. 13 on heading image data 1301. Namely, by displaying the associated heading image data in a direction perpendicular to a direction of the timeline, it is possible to make the user recognize the association relation.

Referring back to FIG. 12, when it is determined that the determined attention area does not agree with the previously determined attention area (No at Step S1201), the attention-area-relation generating unit 209 determines whether the determined attention area is moved by a zooming operation of a scrolling operation (Step S1202).

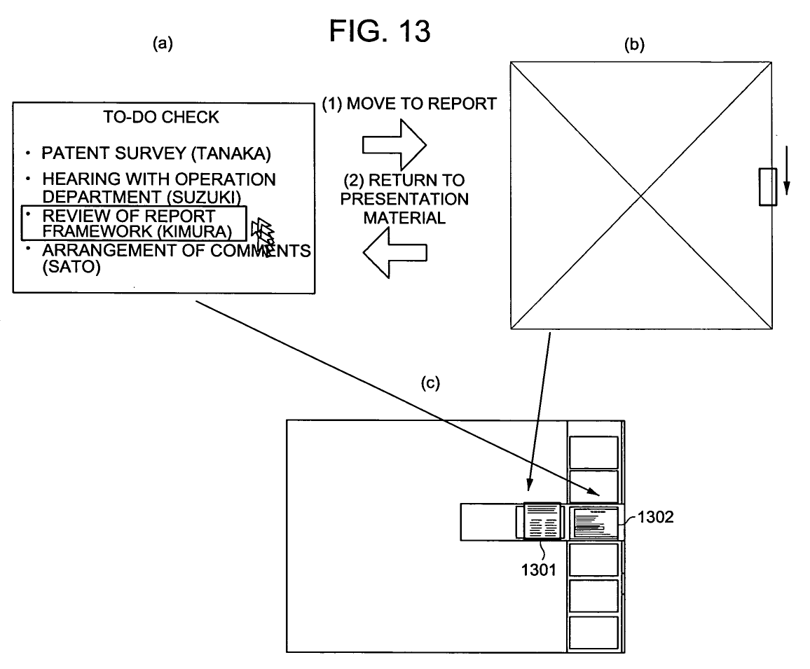

A case where the determined attention area has been moved by the zooming operation is explained below with reference to FIG. 14. The presentation data shown in screen (a) of FIG. 14 is displayed first. After that, the presentation data is zoomed in by an operation of a user, as shown in screen (b) of FIG. 14.

In this case, the attention-area-relation generating unit 209 construes that there is a relation between the presentation data before and after performing the zooming operation, and performs an association with each other. To perform such association, it is necessary to set in advance a rule for determining the presentation data before and after the zooming operation as the attention area in the attention-area determination rule. Namely, it is considered that, when the presentation data is zoomed in, the area to which an attention should be paid is included in the presentation data.

When the attention-area-relation generating unit 209 performs such association, the meeting server 100 displays a screen shown in screen (c) of FIG. 14 on the timeline of the whiteboard 103. As shown in screen (c) of FIG. 14, the meeting server 100 displays heading image data generated from the presentation data before zooming in on heading image data 1401, and heading image data generated from the presentation data after zooming in on heading image data 1402. The heading image data 1401 and the heading image data 1402 are displayed in a direction perpendicular to the direction of the timeline.

Referring back to FIG. 12, when it is determined that the determined attention area is not moved by a zooming operation of a scrolling operation (No at Step S1202), the attention-area-relation generating unit 209 does not perform any particular process, and ends the process.

When it is determined that the determined attention area agrees with the previously determined attention area (Yes at Step S1201), or when it is determined that the determined attention area is moved by a zooming operation or a scrolling operation (Yes at Step S1202), the attention-area-relation generating unit 209 performs an association between the attention areas (Step S1203). For instance, when it is determined that the determined attention area agrees with the previously determined attention area, the attention-area-relation generating unit 209 acquires “heading start time” indicating the previously determined attention area from the heading-information management table in the heading-information storing unit 211. After acquiring the time, the attention-area-relation generating unit 209 associates the time with the determined attention area, and ends the process.

After that, a process of Step S1106 shown in FIG. 11 is performed. With this scheme, when there is an associated attention area, “relevant heading time” indicating a relevant attention area is stored in the heading-information management table shown in FIG. 9.

Namely, when the attention area is extracted by a zooming operation or a scrolling operation, or when the attention area is returned to the original attention area after moving to other area by, for example, browsing other material, it is considered that the attention areas before and after have a relation with each other. Therefore, the attention-area-relation generating unit 209 performs an association between those attention areas.

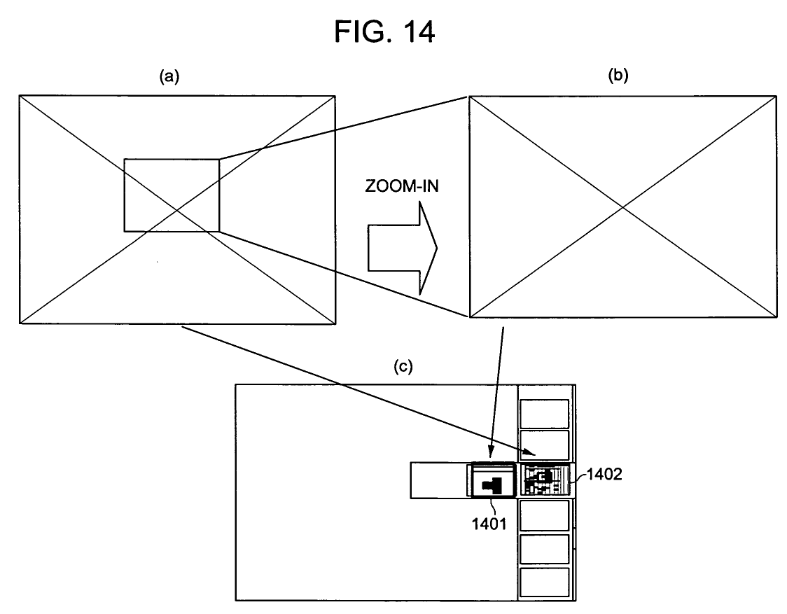

As shown in FIG. 15, the highlight displaying unit 242 displays the relevant heading image data beside the timeline in conjunction with each other. The attention area is displayed in a highlighting manner in the heading image data displayed by the highlight displaying unit 242. Furthermore, by referring to the heading, a user can recognize a relation between the headings. Upon the user pointing the heading image data displayed by the highlight displaying unit 242 with the pen device 105, the heading-information displaying unit 205 performs a display of the presentation data corresponding to the heading image data.

Although the present embodiment takes a scheme in which the relevant headings are displayed beside the time line in conjunction with each other, the present invention is not limited to this display format. Any kind of display format can be used as long as the relation between the attention areas can be recognized, for example, the headings cha be coupled in a vertical direction, can be displayed in a decorated manner, or can be displayed in a pop-up style with a selection of a heading displayed on the timeline.

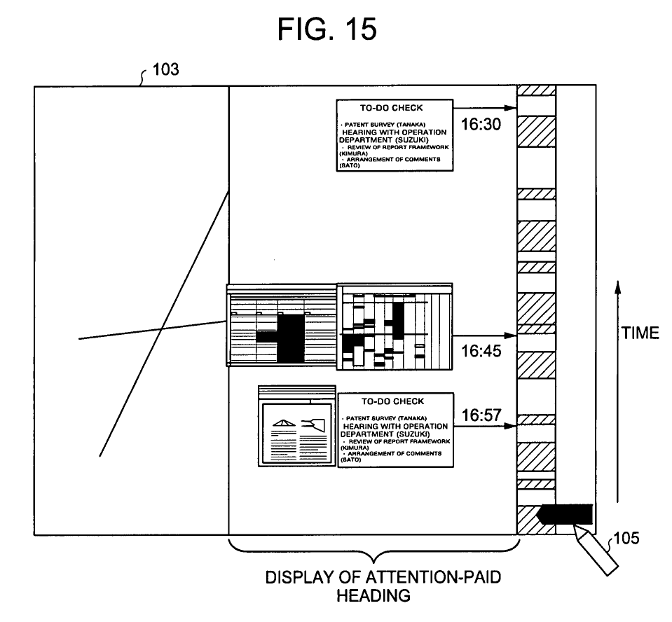

A processing procedure performed by the highlight displaying unit 242 for displaying the heading image data on the timeline is explained below with reference to FIG. 16. This processing procedure is performed in parallel with a process of recording the conference information and the feature amount at the time of starting the conference shown in FIG. 10. Namely, the heading information displayed on the timeline is successively changed according to the feature amount and the heading information stored and generated, respectively, with a progress of the conference.

The highlight displaying unit 242 sets a range for displaying the timeline on the whiteboard 103 (Step S1601).

Subsequently, the highlight displaying unit 242 calculates a frame width to be displayed on the timeline, based on the type of feature amount and time in the event management table shown in FIG. 4 (Step S1602).

After that, the highlight displaying unit 242 specifies an attention area to be displayed according to the time window on the timeline (Step S1603). For instance, a threshold of an attention amount is set in the meeting server 100 in association with the time window. The highlight displaying unit 242 can specify the threshold of the attention amount in the attention area to be displayed according to the calculated frame width. The highlight displaying unit 242 extracts an attention area for which the attention amount stored in a record is larger than the specified threshold from the attention-area management table shown in FIG. 8. The extracted attention area becomes a target to be displayed.

Then, the highlight displaying unit 242 acquires heading information corresponding to the extracted attention area from the attention-area management table (Step S1604). The attention area is assumed to be highlighted in the heading image data to be acquired. The caption stored as the heading information can also be associated so that it is displayed on the timeline as appropriate.

After that, the highlight displaying unit 242 performs a display process of the heading information associated on the timeline (Step S1605). Such processes are performed as appropriate with a progress of the conference.

In this manner, the heading information on the timeline is updated to latest heading information with the attention area highlighted in accordance with a progress of the conference. With this scheme, a user can easily find desired heading information from the presentation data displayed past according to a progress of the conference as appropriate.

Although a case where the attention area of the heading image data is zoomed in is explained as an example according to the present embodiment, the present invention is not limited to this scheme. Any kind of display format can be used as long as a user can recognize the attention area by referring to the heading, for example, a text item included in the attention area can be displayed in boldface, a text item can be underlined, or a font color of a text item can be changed.

Furthermore, although the present embodiment takes a scheme in which the heading image data is generated in advance before displaying, and stored in the heading-information storing unit 211, the present invention is not limited to this scheme. For instance, only a specification of the attention area can be performed first so that the heading image data is generated later when displaying the heading information on the timeline.

As described above, in the heading image data generated by the meeting server 100 according to the present embodiment, a highlighting process is performed on an attention area that is considered to have got an attention from the participants at a conference. Therefore, a user can easily find a portion to which an attention has been paid at the conference from a display of the heading image data.

Furthermore, the meeting server 100 according to the present embodiment can display the heading information with a highlight display according to the attention area on the timeline displayed on the whiteboard 103. With such type of display, a user can easily call important presentation data at the conference again on the whiteboard 103 from the timeline.

Moreover, the meeting server 100 according to the present embodiment calculates the attention area of the presentation data from a plurality of feature amounts extracted from external data. In other words, the heading information with the attention area highlighted can be generated and displayed without performing a special operation for identifying the attention area by a user. According to a user who uses the conference supporting system according to the present embodiment and a situation of the conference, appropriate heading information is displayed on the timeline. Therefore, a user can easily find desired heading information on the timeline during the conference.

Furthermore, the meeting server 100 according to the present embodiment changes the threshold of the attention amount according to the time window. Therefore, it is possible to display appropriate heading information according to a change of the time window on the timeline. Furthermore, according to a time range of the timeline displayed on the whiteboard 103, the number of pieces of the heading information to be displayed can be suppressed to a number that can be recognized by a user.

In addition, as for the heading information, a feature icon indicating an importance according to the type of the feature amount and the amount of attention or a caption of heading acquired from an attribute of the feature amount can be displayed, as well as the heading image data. By displaying the feature icon or the caption of heading, it becomes easy to specify the presentation data required by a user during the conference from a plurality of pieces of heading information displayed.

Moreover, the meeting server 100 according to the present embodiment adjusts the frame width on the timeline according to the feature amount. By referring to the adjusted frame width, a participant can make a visual determination of an important portion during the conference. In addition, when referring to a previous conference by using a slider on the timeline, the more important a scene is during the conference, the finer time window can be used for a reference.

Furthermore, the meeting server 100 according to the present embodiment displays the attention area of the presentation data in a highlighting manner in the heading image data. Therefore, a user can immediately specify an important point of a slide by referring to the heading image data of a slide having a number of texts.

In the meeting server 100 according to the present embodiment, a natural response of a user when an explanation or the like is performed for an area to which an attention should be paid at the time of displaying the presentation data is set as the attention-area determination rule. Therefore the meeting server 100 can determine the attention area from a natural response of a user without necessitating a special operation by the user for specifying the attention area in the conference, and display a digest or a heading image with which the user can easily understand the attention area at the time of browsing.

The present invention is not limited to the present embodiment, but can be applied to a variety of modifications as described below.

Although the present embodiment takes a scheme in which the attention-area highlighting method is fixed for each rule, the attention-area highlighting method can be changed as appropriate. As a modification of the present embodiment, a case where the meeting server changes the attention-area highlighting method as appropriate is explained below.

According to the modification, because a display area of each of the heading image data is changed if a resolution of the screen is changed or the number of heading images to be displayed at once is changed, the meeting server changes the highlighting method according to the changes.

For instance, in the case where a display area of the heading image data becomes small, the meeting server displays the heading image data by increasing the level of highlighting. With this scheme, even if the entire contents of the heading image data cannot be figured out, a user can recognize at least the contents described in the attention area. In addition, when it is determined that a display area of the heading image data is changed, the meeting server calculates an appropriate highlighting method, and dynamically performs a generation and a display of the heading image data by using the existing attention-area management table and the like.

By performing such processes, even when a display area of the heading image data is reduced with a progress of the conference, a user can recognize the presentation data and the attention area to which an attention has been paid during the conference.

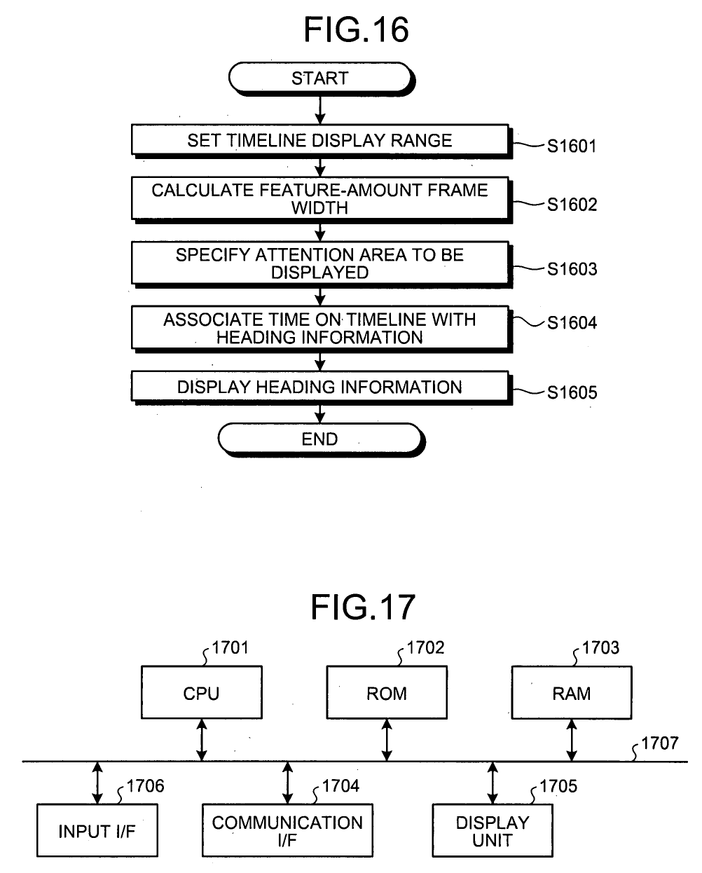

As shown in FIG. 17, the meeting server 100 includes a central processing unit (CPU) 1701, a read only memory (ROM) 1702, a random access memory (RAM) 1703, a communication interface (I/F) 1704, a display unit 1705, an input I/F 1706, and a bus 1707. The meeting server 100 can be applied to a general computer having the above hardware configuration.

The ROM 1702 stores an information displaying program and the like for performing a heading-image-data generating process in the meeting server 100. The CPU 1701 controls each of the units of the meeting server 100 according to the program stored in the ROM 1702. The RAM 1703 stores various data required for controlling the meeting server 100. The communication I/F 1704 performs a communication with a network. The display unit 1705 displays a result of a process performed by the meeting server 100. The input I/F 1706 is an interface for a user input. The bus 1707 connects each of the units.

The information displaying program executed on the meeting server 100 according to the present embodiment is provided by being recorded in a computer-readable recording medium such as a compact disk-read only memory (CD-ROM), a flexible disk (FD), a compact disk-recordable (CD-R), and a digital versatile disk (DVD), as a file of an installable or an executable format.

In this case, the information displaying program is loaded on a main memory by being read from the recording medium and executed on the meeting server 100, so that each of the units is generated on the main memory.

Furthermore, the information displaying program executed on the meeting server 100 according to the present embodiment can be provided by storing the program in a computer connected to a network such as the Internet so that the program can be downloaded via the network. In addition, the information displaying program executed on the meeting server 100 according to the present embodiment can be configured to be provided or distributed via a network such as the Internet.

Moreover, the information displaying program executed on the meeting server 100 according to the present embodiment can be provided by being incorporated in a ROM and the like.

The information displaying program executed on the meeting server 100 according to the present embodiment has a module structure including each of the units. As for an actual hardware, the CPU (processor) reads the information displaying program from the recording medium and executes the program so that the program is loaded on a main memory, and each of the units is generated on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for displaying presentation information, comprising:
a presentation displaying unit that displays the presentation information on a display unit;
a pointing reception unit that receives a pointing to the display unit from a user;
a pointing-area detecting unit that detects a pointing area with respect to a predetermined coordinate area including the displayed presentation information;
a rule storing unit that stores an attention-area determination rule for specifying an attention area from the pointing area;
an attention-area determining unit that determines an attention area with respect to the presentation information based on the pointing area detected by the pointing-area detecting unit and the attention-area determination rule; and
a highlight displaying unit that displays the attention area determined by the attention-area determining unit in a highlighting manner with respect to the presentation information.

2. The apparatus according to claim 1, wherein the highlight displaying unit displays time-axis information indicating an elapse of time for which a presentation is performed, and displays the attention area determined by the attention-area determining unit in a highlighting manner in association with a time at which the presentation information is displayed in the time-axis information.

3. The apparatus according to claim 1, wherein the attention-area determining unit identifies a display area including the detected pointing area from display areas obtained by dividing the presentation information in a predetermined block, and determines the identified display area as the attention area.

4. The apparatus according to claim 3, wherein the attention-area determining unit identifies a line area including the detected pointing area from line areas obtained by dividing text information included in the presentation information in a block of line, and determines the identified line area as the attention area.

5. The apparatus according to claim 1, wherein
the attention-area determination rule includes a condition for the pointing area and a range of the attention area when satisfying the condition in association with each other, and
the attention-area determining unit determines the range of the attention area associated with the condition in the attention-area determination rule as the attention area, when the detected pointing area satisfies the condition.

6. The apparatus according to claim 1, further comprising:
an speech acquiring unit that acquires speech information from a voice of the user, wherein
the pointing-area detecting unit detects the pointing area based on the speech information acquired by the speech acquiring unit.

7. The apparatus according to claim 6, wherein the pointing-area detecting unit detects an area including a character string as the pointing area, when contents of the voice included in the speech information acquired by the speech acquiring unit agrees with the character string displayed as the presentation data.

8. The apparatus according to claim 1, wherein the highlight displaying unit displays a text or a figure included in the attention area in a zooming-in manner.

9. A method for displaying presentation information, comprising:
displaying the presentation information on a display unit;
receiving a pointing to the display unit from a user;
detecting a pointing area with respect to a predetermined coordinate area including the displayed presentation information;
determining an attention area with respect to the presentation information based on the detected pointing area and an attention-area determination rule stored in a rule storing unit; and
highlight-displaying the determined attention area in a highlighting manner with respect to the presentation information.

10. The method according to claim 9, wherein, in the highlight-displaying, time-axis information indicating an elapse of time for which a presentation is performed is displayed, and the attention area is displayed in a highlighting manner in association with a time at which the presentation information is displayed in the time-axis information.

11. The method according to claim 9, wherein, in the determining, a display area including the detected pointing area is identified from display areas obtained by dividing the presentation information in a predetermined block, and the identified display area is determined as the attention area.

12. The method according to claim 11, wherein, in the determining, a line area including the detected pointing area is identified from line areas obtained by dividing text information included in the presentation information in a block of line, and the identified line area is determined as the attention area.

13. The method according to claim 9, wherein
the attention-area determination rule includes a condition for the pointing area and a range of the attention area when satisfying the condition in association with each other, and
the range of the attention area associated with the condition in the attention-area determination rule is determined as the attention area in the determining, when the detected pointing area satisfies the condition.

14. A computer program product having a computer readable medium including programmed instructions for displaying presentation information, wherein the instructions, when executed by a computer, cause the computer to perform:
displaying the presentation information on a display unit;
receiving a pointing to the display unit from a user;
detecting a pointing area with respect to a predetermined coordinate area including the displayed presentation information;
determining an attention area with respect to the presentation information based on the detected pointing area and an attention-area determination rule; and
highlight-displaying the determined attention area in a highlighting manner with respect to the presentation information.

15. The computer program product according to claim 14, wherein, in the highlight-displaying, time-axis information indicating an elapse of time for which a presentation is performed is displayed, and the attention area is displayed in a highlighting manner in association with a time at which the presentation information is displayed in the time-axis information.

16. The computer program product according to claim 14, wherein, in the determining, a display area including the detected pointing area is identified from display areas obtained by dividing the presentation information in a predetermined block, and the identified display area is determined as the attention area.

17. The computer program product according to claim 14, wherein, in the determining, a line area including the detected pointing area is identified from line areas obtained by dividing text information included in the presentation information in a block of line, and the identified line area is determined as the attention area.

18. The computer program product according to claim 14, wherein
the attention-area determination rule includes a condition for the pointing area and a range of the attention area when satisfying the condition in association with each other, and
the range of the attention area associated with the condition in the attention-area determination rule is determined as the attention area in the determining, when the detected pointing area satisfies the condition.
